(19) United States
(12) Patent Application Publication
(10) Pub. No.: US 2025/0198898 A1
(43) Pub. Date: Jun. 19, 2025

(54) METHOD AND SYSTEM FOR CHARACTERIZING ORGANIC LIVE PARTICLE TYPES IN WATER

(71) Applicant: Nocoli AB, Halmstad (SE)

(72) Inventor: Ying FU, Mölndal (SE)

(21) Appl. No.: 18/875,371

(22) PCT Filed: Jul. 7, 2023
(86) PCT No.: PCT/SE2023/050722

§ 371 Date: Dec. 16, 2024

(30) Foreign Application Priority Data
Jul. 12, 2022 (SE) 2250898-0

(51) Int. Cl. G01N 15/01; G01N 15/00; G01N 15/14; G01N 27/30

(52) U.S. Cl. CPC G01N 15/01; G01N 15/1425; G01N 27/30; G01N 2015/0003; G01N 2015/0053

(57) ABSTRACT

The present disclosure relates to a method (100) for characterizing charged/polarizable organic live particle types in water comprising applying (101) a first time-dependent electric bias across a first pair of electrodes, so to generate a first space-time-dependent electric field in a sample of water. Further the method determines (102) background ion characteristics in said sample of water based on said first electric field. Further the method applies (103) a second time-dependent electric bias across at least a second pair of electrodes. Further, the method comprises obtaining (104) kinetic motion data of the captured particles. Additionally, the method determines (105) the presence/identity of a charged/polarizable organic live particle type.

### TECHNICAL FIELD

The present disclosure relates to a method and system for characterizing organic live particle types in water.

### BACKGROUND ART

Water is essential for all life on earth, access to safe drinking water, and therefore quick assessment about the safety of drinking water, is thus of critical importance.

Conventional techniques for assessing water quality, i.e., to characterize whether any unwanted organic live particles are present in water, are usually chemical and biological, which are either time-consuming, expensive, or a combination thereof. There is a need for systems and methods to rapidly and in a convenient manner assess e.g. water for drinking, recycled water for irrigation, sewage treatment plant overflow, garbage that leaks to the groundwater, and bathing water in order to ensure safe water usage, specifically there is a need for systems and methods that rapidly and in a convenient manner allows for characterizing organic live particle types in water, for example, Escherichia coli (E. coli).

### SUMMARY

It is therefore an object of the present disclosure to provide a method and a system to mitigate, alleviate or eliminate one or more of the above-identified deficiencies and disadvantages in assessing water quality.

This object is achieved by means of providing a system and a method as defined in the appended claims.

The present disclosure relates to a method for characterizing (which may be interchanged with “determining the presence/identity of”) charged/polarizable organic live particle (or organic or live) types, hereinafter also referred to as the particle, in water comprising applying a first time-dependent electric bias across a first pair of electrodes, so to generate a first space-time-dependent electric field in a sample of water.

To identify and quantify a specific particle in the sample of water, the method further comprises the step of determining background ion characteristics in said sample of water based on a response to the first space-time-dependent electric field applied across the first pair of electrodes. Background ion characteristics may be at least one of mass, concentration, charge and chemical properties of the ionic/polarizable (fine) particles in said sample of water. The background ion characteristics may in some aspects be ion concentration and mass. The space-time dependent electric field may be a uniform electric field, suitable for measuring ionic particles, or, a space-distributed electric field suitable for measuring polarizable particles.

It should be noted that the first time-dependent electric bias may be applied by applying a first bias voltage. However, in some aspects, the first time-dependent electric bias may comprise to apply a first bias, V1 to one of the electrodes of the first pair and a second bias, V2 to the other of the electrodes of the first pair. V1 and V2 may be applied to obtain a symmetric response voltage Vr. An advantage of this is that it allows for determining ion concentration more efficiently. The bias V1, V2 may be an alternating bias, preferably the alternating bias may be applied to V1 and V2, in a complementing manner relative each other. An advantage of the alternating bias is that it reduces risk of unwanted coating on the electrodes.

Further, the method comprises applying a second time-dependent electric bias across at least a second pair of electrodes to generate at least one particle-specific space-time-dependent electric field in said sample of water thereby capturing particles between said second pair of electrodes. Also, the method comprises obtaining kinetic motion data of the captured particles between said second pair of electrodes.

Moreover, the method determines the presence/identity of a charged/polarizable organic live particle type by comparing said kinetic motion data and background ion characteristics to a pre-determined data set comprising characteristic kinetic motion data of specific particle types based on different background ion characteristics (e.g. based on different water environments). Determining the presence of the particle may also comprise determining the concentration of said specific particle type by quantification.

Thus, the pre-determined data set comprises information of characteristic kinetic motion of e.g., a specific particle in a specific background ion characteristics (water environment). Particles have different characteristic motions in the water based on specific background ion characteristics. Thus, the method matches the kinetic motion obtained (or recorded) to a characteristic kinetic motion of a specific particle in a background ion characteristics (water environment) (as the determined background ion characteristics) in said data set. In other words, the method compares and matches the kinetic motion data to a characteristic kinetic motion data in said data set, wherein said kinetic motion data and said characteristic kinetic motion data comprise common background ion characteristics. Hence, when comparing/matching, the method matches the kinetic motion data to corresponding kinetic motion data having a common background ion characteristics as the determined background ion characteristics. Thus, the pre-determined data set may partition the characteristic motion data therein based on background ion characteristics.

The background ion characteristics may comprise ionic strength, ionic response time, temperature and ionic charge of said background ionic/polarizable (fine) particles in said sample of water.

Thus, allowing for obtaining information of the background ionic/polarizable particles, their concentrations, the mass and charge of the ionic/polarizable particles. Particles in the water attract these background ionic/polarizable particles (now called counterions that accompany the particles) which will affect the kinetic motion of the particles in the water.

A benefit of the method herein is that the space-time-dependent electric field E(r,t) between the second electrode pair will exert a force F(t)=∫q(r)E(r,t)dr on a particle having a charge/polarization distribution q(r). By Newton' second law, F=ma, where “m” is the mass and “a” the acceleration, the space-time-dependent electric field E(r,t) exerts a net force on the particle towards the spatial region between the said second pair of electrodes, thus capturing the particle. Further, the mass m and charge q(r) of the particle may be determined by the kinetic motion data. Specifically, a time sequence of the kinetic motion, allows to calculate a(t), the acceleration may thereafter be utilized to obtain m and q(r).

In some aspects, the method may determine presence of specific particles conditional on that said specific particle (that is aimed to be characterized) is charged and/or electrically polarizable. Such particles undergo characteristic motion in a space-time dependent field, thereby the method can characterize such.

Generally, the method herein, in a time-efficient manner, allows for characterization of particle types in water.

In some aspect, the method may, (preferably but not necessarily, if said at least one particle type is determined as present), further comprise the steps of:
Obtaining fluorescence data of particle in said sample of water;
comparing, said fluorescence data to characteristic fluorescence data (e.g. individual protein fingerprints) of said particle type.

Thus, the fluorescence data, allows the method to determine the identity of a particle with a definite certainty, accordingly, to increase the accuracy of the method.

The characteristic fluorescence data may also be stored in said pre-determined data set. Thus, said pre-determined data set may further comprise characteristic fluorescence data of said determined particle type.

The particle-specific electric field may be an electric field capturing E. Coli particle types. Thus, the time-dependent electric bias and the electrodes (e.g. electrode's geometrical size/spatial configuration/distance) may be adapted for capturing E. coli within the space-time-dependent electric field.

The method may further comprise the step of applying a third time-dependent bias across a third pair of electrodes having a different spatial configuration compared to said second pair of electrodes to generate a different electric field for a different particle type. Thus, the method may be directed to determining the presence/identity of a plurality of particle types based on one method/system. Accordingly, the method may utilize a plurality of electrode pairs each configured (by specifically adapted bias and spatial configuration) for a specific type of particle, so that a plurality of particle types can be determined as present.

The electric field parameters from said particle-specific space-time-dependent electric field are current and voltage parameters measured as functions of time. Thus, the electric field parameters may be a time-resolved response of current and voltage measured. Thus, the time-resolved response may be indicative of the presence/identity of particle types.

The time-dependent electric fields may have dynamic time-durations. The time durations may be in the range of a few microseconds to milliseconds depending on type of background ionic/polarizable particles and specific type of particle.

A benefit of utilizing space-time dependent electric field with dynamic time-durations is to be able to measure the mass and the charge distribution of the said particle separately, while a space-uniform electric field can only measure the ratio between the charge and mass. By Newton' second law, F=ma, where F is the force, m the mass and a the acceleration. In a space-uniform electric field E, F=∫q(r) Edr=E∫q(r)dr=Eq, where q is the total charge; Combine the two equations, qE=ma is obtained, which shows

$$a = E \frac{q}{m} , i$$

i.e., allowing to obtain only the ratio between charge and mass, which may be the same for different particles. The method thus allows the identification of the particle with greatly increased certainty.

There is further a provided system for determining the presence/identity of organic live particle types in water, the system comprising:
at least a first and a second pair of electrodes
control circuitry
a measurement chamber arranged to hold water
   the control circuitry being arranged to perform the method in accordance with any aspect herein.

The system may further comprise a spectrometer to perform fluorescence readout, and an optic readout device (e.g., a fast CMOS camera) to identify kinetic motions of particles.

There is also a provided computer-readable storage medium storing one or more programs configured to be executed by one or more control circuitry of a system, the one or more programs including instructions for performing the method according to any aspect herein.

### BRIEF DESCRIPTION OF THE DRAWINGS

In the following, the disclosure will be described in a non-limiting way and in more detail with reference to exemplary embodiments illustrated in the enclosed drawings, in which:

FIG. 1 schematically in the form of a flowchart illustrates the method in accordance with aspects herein;

FIG. 2 illustrates a system from an objective view in accordance with aspects of the present disclosure;

FIG. 3 schematically illustrates a measurement arrangement in accordance with aspects of the present disclosure;

FIG. 4 illustrates a part of the system herein in accordance with aspects of the present disclosure and schematically illustrates in enlarged sections A and B attraction of background ionic/polarizable particles to electrodes 2 and graphs exemplarily illustrating the time-resolved response; and

FIG. 5 illustrates schematically a part of the system herein in accordance with aspects of the present disclosure showing a circuitry having a first and a second biasing source, each connected to a respective electrode of the pair of electrodes.

### DETAILED DESCRIPTION

In the following detailed description, some embodiments of the present disclosure will be described. However, it is to be understood that features of the different embodiments are exchangeable between the embodiments and may be combined in different ways, unless anything else is specifically indicated. Even though in the following description, numerous specific details are set forth to provide a more thorough understanding of the provided disclosure, it will be apparent to one skilled in the art that the embodiments in the present disclosure may be realized without these details. In other instances, well known constructions or functions are not described in detail, so as not to obscure the present disclosure.

In the following description of example embodiments, the same reference numerals denote the same or similar components.

The term “characterizing” used herein may refer to determining the presence, concentration and identity of a specific particle type.

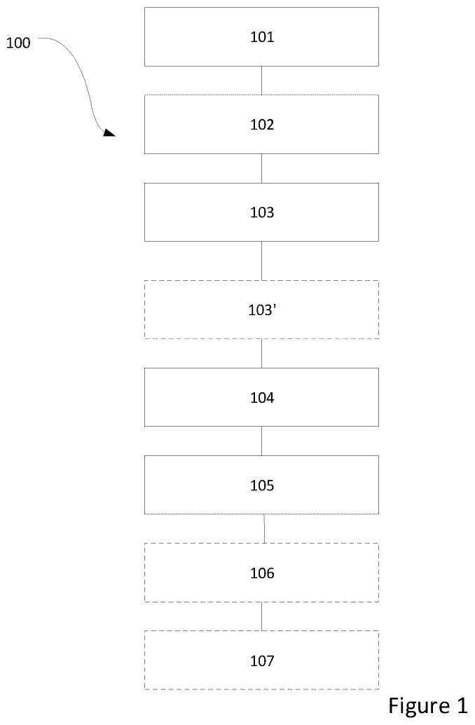

FIG. 1 illustrates, in the form of a flowchart a method 100 for characterizing organic live particle types in water comprising the steps of:
applying 101 a first time-dependent electric bias across a first pair of electrodes, so to generate a first space-time-dependent electric field in a sample of water;
determining 102 background ion characteristics in said sample of water based on said first electric field;
applying 103 a second time-dependent electric bias across at least a second pair of electrodes to generate at least one particle-specific space-time-dependent electric field in said sample of water thereby capturing particles between said second pair of electrodes;
obtaining 104 kinetic motion data of the captured particles;
determining 105 the presence/identity of a charged/polarizable organic live particle type by comparing said kinetic motion data and background ion characteristics to a pre-determined data set comprising characteristic kinetic motion data of specific particle types based on different background ion characteristics.

The method steps 102, 104 and 105 may be computer-implemented steps performed by a control circuitry of an electronic device. Said device may also send control signals for performing method step 101 and 103. The step of determining 102 background ion characteristics allows for the method to conclude the type of environment the water sample belongs/lives in to. There are significant differences in the response time of the positive ions and negative ions based on the water environment. E.g., even a very small amount of salt, such as 10 salt grains added to 50 mL tap water (i.e., ca 0.0007 g salt in 50 mL, while in sea water there is typically close to 0.2 g of dissolved salts in 50 mL), significant difference may be clearly detected in the kinetic motion of the particle and the concise verdicts. Thus, by firstly determining the background ion characteristic, the following determining of the presence/identity of specific particle will be more reliable. It should be noted that the bias applied may be varied within the scope of the present disclosure, e.g. the amplitude of the bias may be 2-25V. The phrase “particle specific electric field” refers to that the electric field is adapted to capture a specific particle types, thus the electric bias and/or spatial configuration of the electrodes may be adjusted to capture a specific particle between the electrode pair.

Further, the step of applying 103 a second time-dependent electric bias so to generate a space-time-dependent electric field allows for particle to be captured i.e. concentrated in a space between paired electrodes. Lifeless particle undergoes typical Brownian motion in water, charged/polarizable/live particle undergoes a characteristic kinetic motion in space-time-dependent electric field. Moreover, the kinetic motion under the influence of an electric field is correlated to the mass and electric charge distribution of the particle. Thus, by applying a particle-specific space-time-dependent electric field, a specific particle type can be targeted and captured, e.g., E. coli types. Data of the corresponding bias that should be applied for each particle-specific electric field may be pre-determined. In some aspects the particles are organic, inorganic, dead or alive. It should be noted that for method step 103, there may preferably be applied a time-dependent bias directly on the electrode pair whose geometric structure, which may be designed specifically for a specific particle (i.e., designed specifically for the charge distribution and the mass of the particle under investigation), may generate a space-time dependent electric field in which the particle will be attracted to the central region between the electrode pair or associated to a region between the electrode pair.

The time-dependent electric bias may be a time-dependent bias comprising a train of different waveforms of different time durations. The pre-determined data set may be a data-set being for example in the form of a look-up-table. However, the method may employ/utilize a trained machine learning algorithm by comparing electric field parameters to said pre-determined data set and thereby determining, based on said comparison presence of particle types. Accordingly, the method step 105, may not only determine presence, but also characterize/identify the specific particle types.

It should be noted that the electric field in the space around the electrodes may be space-dependent based on a shape of the electrodes (forming tubular/finger-like shapes), while the electric bias is time dependent. As further illustrated in FIG. 1, the method 100 may also comprise the steps of (preferably but not necessarily, if said at least particle type is determined as present):
obtaining 106, fluorescence data of particles in said sample of water;
comparing 107 said fluorescence data to characteristic fluorescence data of said determined particle type.

The steps 106, and 107 may also be performed by a trained machine learning algorithm. The step 107 may be used to validate the method herein.

The fluorescence data may be obtained by transmitting in an excitation light beam of short wavelength, e.g., 405 nm, then detecting the fluorescence at long wavelengths. Live organism contains fluorescence proteins, which is characteristic of life, so may be utilized herein as a means to validate identification done in step 105.

Kinetic motion data may be obtained by using an imaging device/optical device configured to capture image data. The imaging device may be a microscope (e.g. with a 100× objective and a fast CMOS camera) configured to record the kinetic motion. Further, the imaging device may comprise image processing means to determine the kinetic motion data. For example, the kinetic motion data may show that a particle is present with a certain reliability, but by also utilizing fluorescence on recorded image(s) one can validate, by checking the presence of fluorescence proteins, so to increase the reliability of assessment about the presence/identity of the particle. The images are preferably recorded sequentially for a time period so to be able to follow eventual increase and quantification of particles around the electrode pairs 2, 3. The kinetic motion data may be obtained by bright-field images captured by the microscope (optical device/imaging device), either reflection or transmission of a transmitted light beam. The method may to not only determine particle types as present, but also characterize/identify and quantify/count said particle types.

The pre-determined data set may further comprises characteristic motion data of said at least one determined particle type and characteristic fluorescence data of said determined particle type. Thus, e.g., comprising data showing that a specific particle type has a specific characteristic motion in said specific environment (which is determined by said background ion characteristics) and additionally comprising data of kinetic motion and fluorescence of specific particles. The pre-determined data set may further comprise data of particle-specific space-time-dependent electric fields for capturing specific particle types, the data being electrode geometry and input bias parameters. Thus, a user utilizing the method may input a specific particle type and obtain, as an output electrode geometry and input bias parameters required to capture said particle.

The background ion characteristics may comprise ionic strength, ionic response time, temperature and ionic charge of said background ionic/polarizable particles in said sample of water. The strength, response time and charge may be obtained by applying a space-time-dependent electric field in which time-resolved response of measured voltage and current from said electric field allows for determining ionic strength, response time and charge of background ionic/polarizable particles.

The particle-specific electric field may be an electric field capturing particle such as E. Coli particle types.

FIG. 1 further illustrates that the method 100 comprise the step of applying 103′ a third time-dependent bias across a third pair of electrodes having a different spatial configuration compared to said second pair of electrodes to generate a particle-specific electric field of a different type compared to said particle-specific electric field generated by said second pair of electrodes. Accordingly, the method 100 may comprise a plurality of electrode pairs, each directed to determining a specific type of particle (live/organic particle type) or E. coli type.

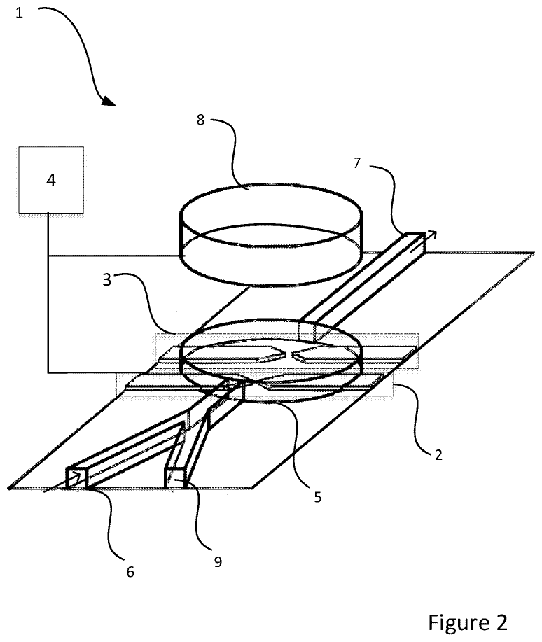

FIG. 2, schematically illustrates a system 1 for determining the presence/identity of particle types in water, the system 1 comprising at least a first and a second pair of electrodes 2, 3, control circuitry 4, a measurement chamber 5 arranged to hold water. The control circuitry 4 being arranged to perform the method 100 in accordance with any aspect herein. Accordingly, the first pair 2 may be directed to be utilized to determine background ion characteristics, wherein the second pair 3 may be utilized to capture a specific particle type so to determine its presence.

As further illustrated in FIG. 2, the system may comprise an inlet 6 that is arranged to receive water that is to be examined. Thus, the inlet 6 leads to said measurement chamber 5 and eventually to an outlet 7. Accordingly, the method 100 may sequentially be performed as the water is passing through the electrode pairs 2, 3. As illustrated in FIG. 2, the water may be inputted in said inlet 6 so to pass a space between each electrode pair 2, 3 respectively towards the outlet 7.

FIG. 2 further illustrates that the system 1 may comprise a measurement arrangement 8 arranged to capture kinetic motion data and optionally fluorescence data of particles in said sample of water. The measurement arrangement 8 may comprise a spectrometer device and an optic readout device (e.g. a microscope). The system 1 may also comprise a temperature sensor so to obtain temperature of background ions/polarizable particles in said water. In some aspects a pH meter device may also be utilized in the system 1 herein.

The control circuitry 4 may comprise one or more memory devices (not shown). The memory devices may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by each associated control circuitry 4. Each memory device may store any suitable instructions, data or information, including a computer program, software, an application including one or more of logic, rules, code, tables, etc. and/or other instructions capable of being executed by the control circuitry 4 and, utilized. Memory device 4 may be used to store any calculations made by control circuitry and/or any data received via output and input interfaces. Thus, the memory device may store pre-determined data sets comprising correlations, and any recordings from the measurement arrangement. In some embodiments, each control circuitry 4 and each memory device may be considered to be integrated. In some embodiments, the memory device and related data are stored in a cloud server accessible by the control circuitry 4.

Each memory device may also store data that can be retrieved, manipulated, created, or stored by the control circuitry 4. The data may include, for instance, local updates, parameters, training data, trained learning algorithms (and/or the models, components, data utilized in said trained learning algorithms e.g data-sets herein). In some aspects, the control circuitry 4 comprises a machine learning component that based on data from the memory device may implement a trained machine learning algorithm, accordingly, the machine learning algorithm may utilize method steps 104-106. The data can be stored in one or more databases. The one or more databases can be connected to the optimization device 2 by a high bandwidth field area network (FAN) or wide area network (WAN), or any wireless network. Accordingly, the control circuitry 4 may comprise data of particle-specific space-time-dependent electric fields for capturing specific particle types, so that a user may, obtain said data for a desired particle type to be identified, and proceed with method step 101 accordingly.

The circuitry 4 may include, for example, one or more central processing units (CPUs), graphics processing units (GPUs) dedicated to performing calculations, and/or other processing devices.

FIG. 2 further illustrates a calibration inlet 9 arranged to receive cleaning fluid (e.g. water) to reset the system for additional measurements.

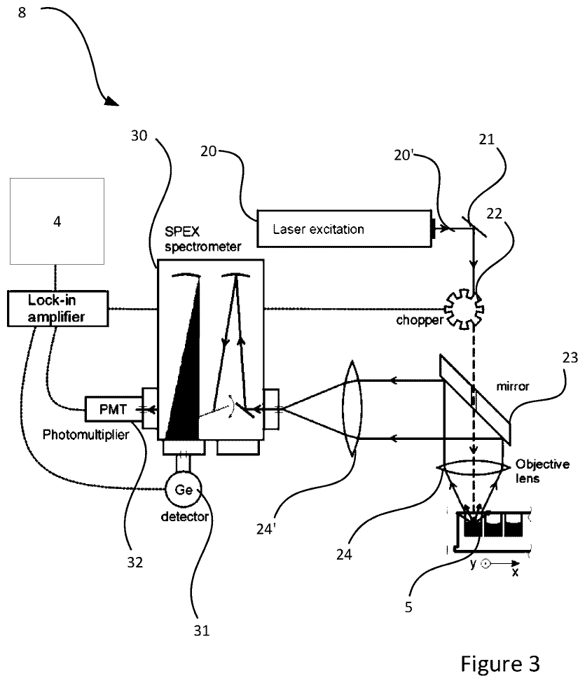

FIG. 3 illustrates schematically a more detailed view of the measurement arrangement and specifically the spectrometer device, illustrating that the arrangement may comprise a laser device 20 arrange to excite laser beams 20′, a reflection means 21, a chopper 22, a mirror 23, an objective lens 24, wherein the laser beam 20′ from the laser device 20 is arranged to penetrate the objective lens 24 and reflect at said water in the chamber 5 back to penetrate the objective lens 24 a second time thereby reflecting at said mirror 23 through a second lens 24′ into a SPEX spectrometer comprising a detector 31 and a photomultiplier 32. Moreover, the signal can through the spectrometer 30 reach the control circuitry 4 that is configured to obtain fluorescence data so to compare the same to characteristic fluorescence data of a specific particle type. It should be noted that the measurement arrangement of FIG. 3 is disclosed merely for a disclosing purpose and could be varied within the knowledge of a skilled man in the art.

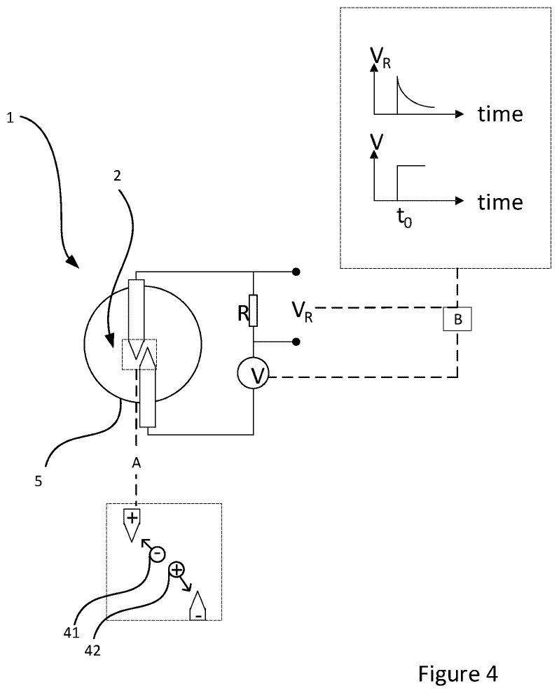

FIG. 4 illustrates schematics of the step of determining 102 background ion characteristics in accordance with aspects of the present disclosure. Section A in an enlarged manner illustrates that at to when the one of the electrons in the pair 2 are positively biased and the other one is negatively biased, the negative background ions 41 are attracted to positively biased, and the positive background ions 42 to the negatively biased electrode, causing the bias V_{R} on the serially-connected resistor R to drop. Section A may illustrate a spatial region in-between said pair of electrodes in an exemplary manner. The change of the V_{R} along the time is the so-called time-resolved response, from which strength, response time, concentrations, charge and mass of the background ions/polarizable particles are obtained. The time resolved response is further illustrated as graphs in section B in FIG. 4. Thus, each electrode pair 2, 3 may be coupled to a bias feed V, and a serially coupled resistor R, wherein the time resolved response derivable from a bias V_{R} across said resistor may be utilized to derive background ion characteristics. The term “captured particles” may refer to that particles are captured in-between (or a region associated to in-between) said pair of electrodes 2, thus kinetic motion data may refer to captured data from a region in-between said pair of electrodes 2.

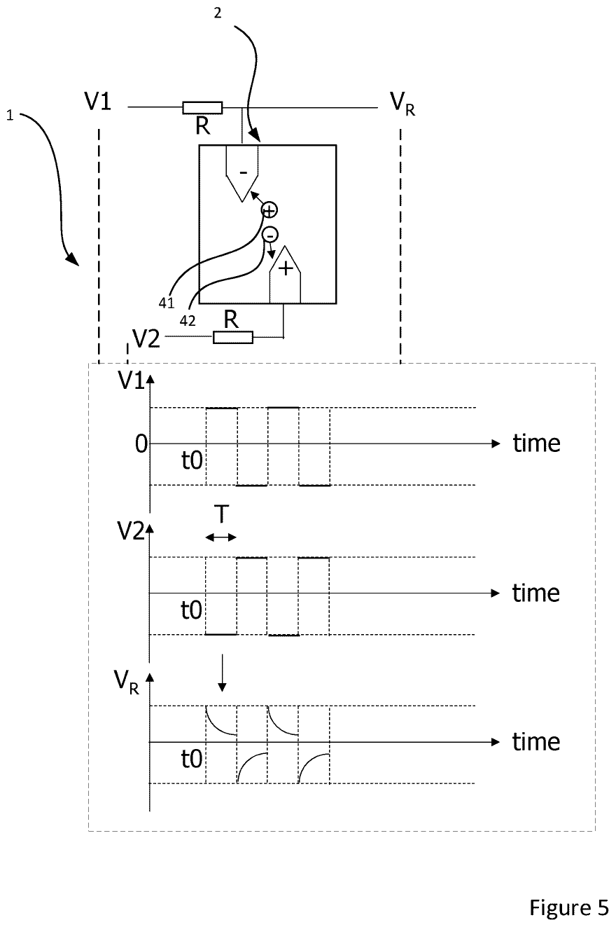

FIG. 5 illustrates schematics of the step of determining 102 background ion characteristics in accordance with aspects of the present disclosure. In FIG. 5 each electrode of said pair of electrodes is biased by a corresponding biasing source such that each electrode is biased independently. FIG. 5 illustrates that at to when the one of the electrons in the pair 2 are positively biased and the other one is negatively biased by separate biasing sources, the negative background ions 41 are attracted to positively biased, and the positive background ions 42 to the negatively biased electrode, causing the bias V_{R} on the resistor R to drop. FIG. 5 illustrates that each electrode is biased separately, in which the bias may be applied to a common time-period and magnitude but complementary such that upon applying a positive bias to the one of the electrodes of the pair, the other electrode of the pair is negatively biased. The time resolved response is further illustrated as graphs showing that the response is symmetric. This allow for background ion characteristics to be obtained conveniently by utilizing the equation (1): V_{R}=a e^{-bt}+c in which t is time in which electric bias is applied, a is proportional to ion concentration, 1/b is proportional to ion mass, c is a device dependent noise-depending on the hardware, hence c may be pre-known/pre-determined. The background ion characteristics may therefore be obtained by correlating the curves of the response to the equation (1). FIG. 5 further illustrates that the circuitry comprises a respective resistor coupled in-between a bias source supplying the probing bias V1, V2 and each electrode. The period T illustrated in FIG. 5 may be adapted based on an amount of mass desired to be measured, for example, a larger period T may allow to measure a larger mass compared to a shorter period T. In other words each bias may be applied for a defined T based on a specific mass (desired to be measured).

1. A method for characterizing charged/polarizable organic live particle types, in water comprising:
applying a first time-dependent electric bias across a first pair of electrodes, so to generate a first space-time-dependent electric field in a sample of water;
determining background ion characteristics in said sample of water based on said first electric field;
applying a second time-dependent electric bias across at least a second pair of electrodes to generate at least one particle-specific space-time-dependent electric field in said sample of water thereby capturing particles between said second pair of electrodes;
obtaining kinetic motion data of the captured particles; and
determining a presence/identity of a charged/polarizable organic live particle type by comparing said kinetic motion data and background ion characteristics to a pre-determined data set comprising characteristic kinetic motion data of specific particle types based on different background ion characteristics.

2. The method according to claim 1, wherein said pre-determined data set further comprises characteristic fluorescence data of said determined particle type, wherein the method further comprises:
obtaining fluorescence data of said captured particles in said sample of water;
comparing said fluorescence data to said characteristic fluorescence data of said determined particle type.

3. The method according to claim 1, wherein the pre-determined data set further comprises data of particle-specific space-time-dependent electric fields for capturing specific particle types, the data being electrode geometry and input bias parameters.

4. The method according to claim 1, wherein said background ion characteristics comprises ionic strength, ionic response time, temperature and ionic charge of said background ions/polarizable particles in said sample of water.

5. The method according to claim 1, wherein said particle-specific electric field is an electric field capturing said particle types, particle types being preferably, E. coli.

6. The method according to claim 1, further comprising the step of applying a third time-dependent bias across a third pair of electrodes having a different spatial configuration compared to said second pair of electrodes to generate another particle-specific electric field of a different type compared to said particle-specific electric field generated by said second pair of electrodes.

7. The method according to claim 1, wherein electric field parameters from said particle-specific space-time-dependent electric field are current and voltage parameters measured as functions of time and space.

8. The method according to claim 1, wherein the space-time-dependent electric fields are generated by first and second time-dependent electric biases being particle-specific waveforms having dynamic time-durations.

9. The method according to claim 1 wherein the step of applying a first time-dependent electric bias across a first pair of electrodes is performed by applying a first bias to a first electrode of said pair of electrodes and a second bias to a second electrode of said pair of electrodes, wherein the first and second bias are alternating biases, wherein the alternating biases are applied to said pair of electrodes complementary relative each other.

10. A system for determining a presence/identity of particle types in water, the system comprising:
at least a first and a second pair of electrodes
control circuitry
a measurement chamber arranged to hold a sample of water;
the control circuitry being arranged to perform the method in accordance with claim 1.

11. A computer-readable storage medium storing one or more programs configured to be executed by one or more control circuitry of a system, the one or more programs including instructions for performing the method of claim 1.
